(19) United States
(12) Patent Application Publication
(10) Pub. No.: US 2007/0064585 A1
(43) Pub. Date: Mar. 22, 2007

(54) Optical recording medium

(75) Inventors: Koji Mishima, Tokyo (JP); Daisuke Yoshitoku, Tokyo (JP)

Correspondence Address: OLIFF & BERRIDGE, PLC, P.O. BOX 19928, ALEXANDRIA, VA, 22320, US

(73) Assignee: TDK CORPORATION, Tokyo (JP)

(21) Appl. No.: 11/485,384

(22) Filed: Jul. 13, 2006

(30) Foreign Application Priority Data
Jul. 15, 2005 (JP) 2005-207200
Apr. 21, 2006 (JP) 2006-118525

(51) Int. Cl. G11B 3/70

(52) U.S. Cl. 369/283

(57) ABSTRACT

An optical recording medium is provided which includes a plurality of recording layers and provides any of the recording layers with a good recording mark. An optical recording medium includes a first recording layer and a second recording layer, in which the second recording layer located relatively closer to an incidence plane of a laser beam is thicker than the first recording layer located farther away from the incidence plane of the laser beam with respect to the second recording layer.

### BACKGROUND OF THE INVENTION

1. Field of the Invention

The present invention relates to an optical recording medium with a plurality of recording layers.

2. Description of the Related Art

Optical recoding media such as CDs (Compact Discs), DVDs (Digital Versatile Discs) are widely used as information recording media. In recent years, attention has been focused on such an optical recording medium which is radiated with a blue or violet laser beam and thus capable of storing a larger amount of information than before.

Optical recording media are largely classified into three types: a ROM (Read Only Memory) type on which data is neither recordable nor rewritable, an RW (Rewritable) type on which data is rewritable, and an R (Recordable) type on which data is recordable only once.

In the case of an R type optical recording medium, a recording layer is irradiated with a laser beam to form a recording mark having a lower reflectivity than that of a neighboring space portion, thereby allowing data to be recorded. Note that although the space portion adjacent to the recording mark is also irradiated with the recording laser beam, the amount of light of the recording laser beam irradiating the space portion is small and thus the reflectivity of the space portion is equivalent to the reflectivity of the recording layer that has not yet been irradiated with the laser beam. Additionally, with the R type optical recording medium, the recording layer is irradiated with a laser beam, so that a photodetector detects the difference between the reflectivity of the recording mark and the reflectivity of the space portion, thereby allowing for reproducing data.

Such an optical recording medium can include a plurality of recording layers, thereby providing a recording capacity increased by that amount. To record data on an R type optical recording medium having a plurality of recording layers, a recording laser beam can be controlled to focus on an intended recording layer, thereby selectively recording data on the intended recording layer. On the other hand, a reproducing laser beam can also be controlled to focus on an intended recording layer, thereby selectively reproducing data on the intended recording layer.

Preferably, such an R type optical recording medium having a plurality of recording layers is configured such that each recording layer is irradiated with a reproducing laser beam at equal power, and thereby the intensities of reflected lights from each recording layer to be detected by a photodetector are as close as possible to each other. More specifically, it is preferable that the reflectivities of reflected lights from two adjacent recording layers to be detected by the photodetector should be as close to each other as within a range of less than two times.

However, a lower recording layer located relatively farther away from an incidence plane of a laser beam is irradiated with a laser beam through the upper recording layer, and a portion of this laser beam is absorbed through the upper recording layer, thereby causing the amount of light of the laser beam reaching the lower recording layer to be reduced by that amount.

Thus, when the power of the reproducing laser beam irradiating the lower recording layer is equal to the power of the reproducing laser beam irradiating the upper recording layer, the amount of light of the laser beam reaching the lower recording layer becomes less than the amount of light of the laser beam reaching the upper recording layer. Furthermore, since the reflected light of the laser beam irradiating the lower recording layer reaches the photodetector through the upper recording layer, a portion of the reflected light is also absorbed through the upper recording layer. Thus, when the power of the reproducing laser beam irradiating the lower recording layer is equal to the power of the reproducing laser beam irradiating the upper recording layer, and the reflectivity of the lower recording layer is equal to the reflectivity of the upper recording layer, the reflectivity of the lower recording layer to be detected by the photodetector will be lower than the reflectivity of the upper recording layer.

In contrast to this, there is known an R type optical recording medium which has an upper recording layer reduced in thickness relative to the lower recording layer (e.g., see Japanese Patent Laid-Open Publication No. 2003-266936). Its operation will be briefly explained. FIG. 6 is a graph showing the relationship between the thickness and the reflectivity of a single-layer recording layer. Note that in FIG. 6, the curve indicated by symbol S denotes the reflectivity of a space portion of the recording layer, while the curve indicated by symbol M denotes the reflectivity of a recording mark.

As indicated by the curve with symbol S, the recording layer has the maximum reflectivity of the space portion at a given thickness, and tends to have a reduced reflectivity at thicknesses either greater or less than that. On the other hand, as indicated by the curve with symbol M, the recording mark also has the maximum reflectivity at generally the same thickness, and tends to have a reduced reflectivity at thicknesses either greater or less than that. Furthermore, the difference between the reflectivity of the recording mark and the reflectivity of the space portion is at the maximum near the thickness at which those reflectivities take the maximum values, and decreases at thicknesses either greater or less than that. Thus, an excessively increased or decreased thickness of the recording layer would cause the difference in reflectivity to be too reduced to read the recording mark.

Thus, for example, the lower recording layer can be formed in a thickness at which the reflectivity is maximized, with the upper recording layer made thinner than the lower recording layer, thereby allowing the reflectivity of the lower recording layer to be higher than the reflectivity of the upper recording layer. For this configuration, the reflectivities of the reflected lights from both the recording layers to be detected by a photodetector can be close values, even in the case where the power of the laser beam irradiating the lower recording layer is equal to the power of the laser beam irradiating the upper recording layer, thereby the amount of light of the laser beam reaching the lower recording layer is less than the amount of light of the laser beam reaching the upper recording layer, and the reflected light of the laser beam irradiating the lower recording layer is partially absorbed through the upper recording layer then reaches the photodetector.

Note that a region of thicknesses greater than the thickness at which the reflectivity is maximized provides a narrow range of sufficient differences between the reflectivity of the recording mark and the reflectivity of the space portion. Furthermore, in this range, the reflectivity of the upper recording layer cannot be sufficiently reduced with respect to the reflectivity of the lower recording layer which is nearly at the maximum value. Also in this regard, the structure is selected in which the upper recording layer is thinner than the lower recording layer.

Furthermore, the upper recording layer being made thinner than the lower recording layer allows the amount of the laser beam absorbed through the upper recording layer to be reduced and the amount of light of the laser beam reaching the lower recording layer to be increased. Also in this regard, the structure is selected in which the upper recording layer is made thinner than the lower recording layer.

However, in some cases, the upper recording layer being made thinner than the lower recording layer would not allow the upper recording layer to be provided with a good recording mark of a desired property. More specifically, with the upper recording layer made thinner as described above, the upper recording layer causes the recording mark and its neighboring space portion to be reduced in reflectivity, and the difference in reflectivity between them is also decreased. Accordingly, in some cases, when the upper recording layer is made thinner sufficiently enough to increase the amount of light of the laser beam reaching the lower recording layer, the upper recording layer would not be provided with a recording mark of a sufficiently lower reflectivity relative to that of the space portion.

### SUMMARY OF THE INVENTION

In view of the foregoing problems, various exemplary embodiments of this invention provide an optical recording medium which has a plurality of recording layers and allows a good recording mark to be formed in any of the recording layers.

To achieve the aforementioned object, various exemplary embodiments of this invention provide an optical recording medium including a plurality of recording layers, in which one of the recording layers located relatively closer to an incidence plane of a laser beam is thicker than another recording layer located farther away from the incidence plane of the laser beam with respect to the one recording layer.

The inventors tried forming recording layers of various materials in the course of achieving the present invention. As a result, it was found that a recording layer formed of a given material has a significantly reduced extinction coefficient as compared with the conventional recording layers. It was also found that when irradiated with a laser beam, this recording layer is provided with a recording mark increased in thickness relative to the neighboring space portion.

As such, the upper recording layer made thicker than the lower recording layer makes it possible to form a good recording mark of a desired property in the upper recording layer.

Furthermore, at least the upper recording layer may be controlled to have an extinction coefficient as low as, e.g., 0.35 or less. Thus, even when the upper recording layer located relatively closer to an incidence plane of a laser beam is made thicker, a laser beam irradiating the lower recording layer located farther away from the incidence plane of the laser beam relative to the upper recording layer is absorbed with difficulty through the upper recording layer. It is thus possible to increase the reflectivity of the lower recording layer to be detected by a photodetector as well as to form a good recording mark also in the lower recording layer.

Furthermore, when a recording mark is formed which is increased in thickness relative to the neighboring space portion, the reflectivity of the recording mark becomes equal to the reflectivity of a recording mark in a recording layer which is thicker by a thickness corresponding to the increase in thickness, in contrast to the reflectivity of the recording mark indicated by the curve denoted with symbol M in FIG. 6 above. In other words, as shown in FIG. 1, the thickness of the recording layer and the reflectivity of the recording mark are related to each other such that the curve denoted by symbol M is translated towards the smaller thickness side by the increase in thickness with respect to that in FIG. 6. This causes the difference between the reflectivity of the space portion and the reflectivity of the recording mark to be increased in the vicinity of a thickness at which the reflectivity of the space portion is maximized as well as in a region of thicknesses greater than that thickness. In particular, in the region of thicknesses greater than the thickness at which the reflectivity of the space portion is maximized, the range of large differences between the reflectivity of the space portion and the reflectivity of the recording mark is extended. In other words, in the region of thicknesses greater than the thickness at which the reflectivity of the space portion is maximized, the thickness of the recording layer can be set in an extended range. Therefore, for example, the thickness of the lower recording layer may be set in the vicinity of the thickness at which the reflectivity of the space portion is maximized, and the upper recording layer may be made thicker than the lower recording layer in order to increase the reflectivity of the lower recording layer relative to the reflectivity of the upper recording layer. Even in this case, it is possible to provide the upper recording layer with a sufficient difference between the reflectivity of the recording mark and the reflectivity of the space portion. Furthermore, by increasing the thickness of the upper recording layer in this manner, it is also possible to form a good recording mark of a desired property in the upper recording layer as described above.

Namely, various exemplary embodiments of the present invention realize an optical recording medium in which the upper recording layer located relatively closer to an incidence plane of a laser beam is formed to be thicker than the lower recording layer located farther away from the incidence plane, thereby providing any of the recording layers with good recording and reproducing properties. Thus, the various exemplary embodiments of the present invention are based on a concept totally different from the conventional one in which the thickness of the upper recording layer was usually made equal to or less than the thickness of the lower recording layer.

Accordingly, various exemplary embodiments of the present invention provide an optical recording medium comprising a plurality of recording layers, one of the recording layers located relatively closer to an incidence plane of a laser beam being thicker than another recording layer located farther away from the incidence plane of the laser beam with respect to the one recording layer.

Note that as used herein, the phrase “the recording layer essentially consists of Bi and O” shall mean that the ratio of the total number of Bi and O atoms in the recording layer to the total number of the atoms that constitute the recording layer is 80% or greater. More preferably, when the recording layer essentially consists of Bi and O, the ratio of the total number of Bi and O atoms in the recording layer to the total number of the atoms that constitute the recording layer is 90% or greater. When the recording layer essentially consists of Bi and O, and the ratio of the total number of Bi and O atoms in the recording layer to the total number of the atoms that constitute the recording layer is 80% or greater, the recording layer may also contain other additional elements than Bi and O. The additional elements may be of one type or two or more types; however, preferably, at least one type of the additional elements is an element that is included in X (X is one type of element selected from the group consisting of Mg, Al, Si, Zn, Ge, Y, Sn, Sb, V, Dy, and Ti) or Z (Z is one type of element selected from the group consisting of Fe, Cu, Mo, Ag, W, Ir, Pt, and Au).

Incidentally, the phrase “the recording layer essentially consists of Bi, O, and X” shall mean that the percentage of the total number of Bi, O, and X atoms in the recording layer is 80% or greater. More preferably, when the recording layer essentially consists of Bi, O, and X, the ratio of the total number of Bi, O, and M atoms in the recording layer to the total number of the atoms that constitute the recording layer is 90% or greater. The same holds true for the phrase “the recording layer essentially consists of Bi, O, and Z.”

According to various exemplary embodiments of the present invention, it is possible to realize an optical recording medium which has a plurality of recording layers and is capable of forming a good recording mark in any of the recording layers.

### BRIEF DESCRIPTION OF THE DRAWINGS

FIG. 1 is a graph showing the relation between the thickness and the reflectivity of a recording layer of an optical recording medium according to a first exemplary embodiment of the present invention;

FIG. 2 is a cross-sectional side view schematically showing the structure around the recording layers of the optical recording medium;

FIG. 3 is a cross-sectional side view schematically showing the entire structure of the optical recording medium;

FIG. 4 is a cross-sectional side view schematically showing the entire structure of an optical recording medium according to a second exemplary embodiment of the present invention;

FIG. 5 is a cross-sectional side view schematically showing the entire structure of an optical recording medium according to a third exemplary embodiment of the present invention; and

FIG. 6 is a graph showing the relation between the thickness and the reflectivity of the recording layer of a conventional optical recording medium.

### DETAILED DESCRIPTION OF THE PREFERRED EMBODIMENTS

Preferred exemplary embodiments of the present invention will now be described in detail with reference to the drawings.

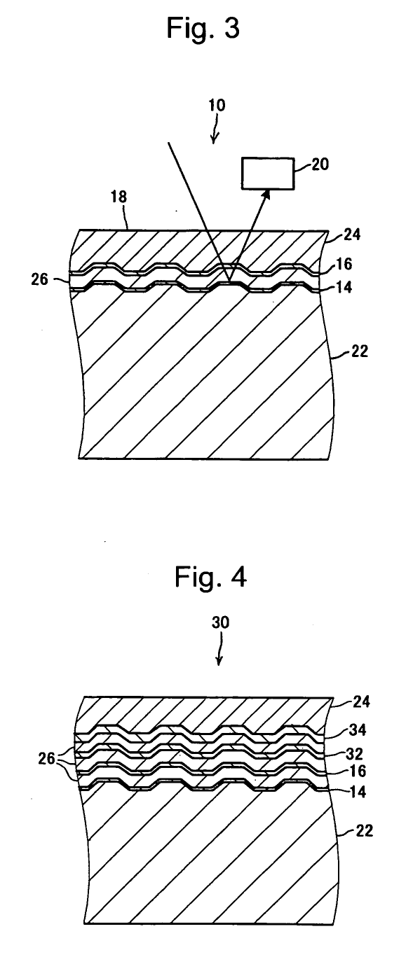

An optical recording medium 10 according to a first exemplary embodiment of the present invention is formed in the shape of a disc having an outer diameter of approximately 120 mm and a thickness of approximately 1.2 mm. As shown in FIGS. 2 and 3, the optical recording medium 10 includes a first recording layer 14 and a second recording layer 16, and the second recording layer 16 located relatively closer to an incidence plane 18 of a laser beam is thicker than the first recording layer 14 located farther away from the incidence plane 18 of the laser beam with respect to the second recording layer 16. The description of the configuration of other portions is appropriately omitted because it is the same as or similar to that of the conventional optical recording medium and does not seem particularly important for understanding of the present exemplary embodiment.

The first recording layer 14 and the second recording layer 16 each have an extinction coefficient of 0.35 or less.

Furthermore, as shown in FIG. 2, the first recording layer 14 and the second recording layer 16 are designed to be irradiated with a laser beam and thereby provided with a recording mark 12 increased in thickness relative to a neighboring space portion 11.

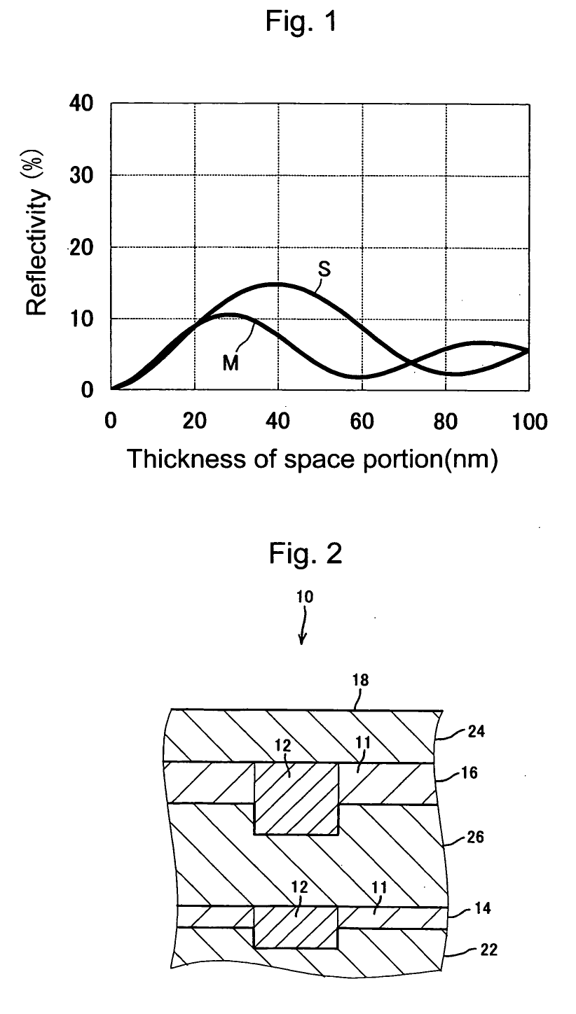

The first recording layer 14 and the second recording layer 16 are substantially formed of Bi and O, such that the percentage of the number of O atoms in these first recording layer 14 and second recording layer 16 is 62% or more. Note that the percentage of the number of O atoms in the first recording layer 14 and the second recording layer 16 is preferably 73% or less. The relations between the thickness and the reflectivity of the recording layers formed of this material are as shown by the curves indicated by symbols S and M in FIG. 1, respectively. The reflectivities shown here are those of the recording layers themselves. As for the second recording layer 16, the reflectivity is generally equal to the reflectivity detected by a photodetector 20, but as for the first recording layer 14, the reflectivity is greater than the reflectivity detected by the photodetector 20. As shown in FIG. 1, the material of these first recording layer 14 and second recording layer 16 has a property that the reflectivity of the space portion 11 is maximized at a given thickness (approximately 40 nm in the first exemplary embodiment).

The first recording layer 14 is formed in a thickness of approximately 45 nm that is generally equal to the thickness at which the reflectivity of the space portion 11 is maximized. On the other hand, the second recording layer 16 located closer to the incidence plane 18 relative to the first recording layer 14 is formed in a thickness greater than the thickness at which the reflectivity of the space portion 11 is maximized. That is, the reflectivity of the first recording layer 14 is higher than the reflectivity of the second recording layer 16.

Note that the first recording layer 14 may be made of a material that contains at least one type of element selected from the group consisting of Fe, Cu, Mo, Ag, W, Ir, Pt, and Au. These elements can be added to improve recording sensitivity. On the other hand, the second recording layer 16 may be made of a material that contains at least one type of element selected from the group consisting of Mg, Al, Si, Zn, Ge, Y, Sn, Sb, V, Dy, and Ti. These elements can be added to reduce the extinction coefficient of the second recording layer 16 and increase the amount of light of a laser beam reaching the first recording layer 14. In this manner, other elements than Bi and O can be added to control the recording sensitivity of the first recording layer 14 and the extinction coefficient of the second recording layer 16. This allows the recording sensitivity of the first recording layer 14 which is thinner than the second recording layer 16 and irradiated with a laser beam through the second recording layer 16 to be brought closer to the recording sensitivity of the second recording layer 16. Furthermore, by reducing the extinction coefficient of the second recording layer 16, the reflectivity of the first recording layer 14 irradiated with a laser beam through the second recording layer 16 to be detected by the photodetector 20 can be brought closer to the reflectivity of the second recording layer 16.

The first recording layer 14 and the second recording layer 16 are formed over a substrate 22, and a cover layer 24 is formed on a side of the second recording layer 16 opposite to the substrate 22. Moreover, there is formed a spacer layer 26 between the first recording layer 14 and the second recording layer 16.

The substrate 22 has a thickness of approximately 1.1 mm and a surface thereof on a side of the cover layer 24 is formed in a concavo-convex pattern forming grooves. Note that the term “groove” commonly refers to a concave portion that is used for recording or reproducing data. However, for convenience, the term “groove” is to be also used herein to refer to a portion used for recording or reproducing data even if the portion is a convex portion which protrudes towards the cover layer 24. In the first exemplary embodiment, the convex portion which protrudes towards the cover layer 24 is a groove. Note that the substrate 22 may be formed of polycarbonate resin, acrylic resin, epoxy resin, polystyrene resin, polyethylene resin, polypropylene resin, silicone resin, fluorine-based resin, ABS resin, or urethane resin.

The cover layer 24 is formed in a thickness of 30 to 150 μm, for example. The cover layer 24 can be formed of a transparent energy beam curable resin such as an acrylic-based ultraviolet curable resin or an epoxy-based ultraviolet curable resin. As used herein, the term “energy beam” is to collectively refer to, e.g., electromagnetic waves and particle beams, such as ultraviolet and electron beams, which have the property of curing a particular fluid-state resin. Note that to form the cover layer 24, a fluid-state resin may be applied onto the substrate and then irradiated with an energy beam to be hardened, or alternatively, a pre-fabricated transparent film may be affixed to the substrate.

For example, the spacer layer 26 has a thickness of approximately 5 to 90 μm, with both the surfaces thereof provided with a concavo-convex pattern forming grooves like that of the substrate 22. Like the material of the cover layer 24, the spacer layer 26 may be formed of a transparent energy beam curable resin such as an acrylic-based ultraviolet curable resin and an epoxy-based ultraviolet curable resin.

The first recording layer 14 is formed in a concavo-convex pattern following the concavo-convex pattern of the substrate 22. The second recording layer 16 is also formed in a concavo-convex pattern following the concavo-convex pattern of the spacer layer 26.

Now, a description will be given to the operation of the optical recording medium 10.

The optical recording medium 10 is configured such that the second recording layer 16 is thicker than the first recording layer 14, the second recording layer 16 is thus provided with a good recording mark of a desired property.

Furthermore, the second recording layer 16 has an extinction coefficient of 0.35 or less. Thus, even when the second recording layer 16 is formed to be thicker, a laser beam irradiating the first recording layer 14 located farther away from the incidence plane 18 of the laser beam relative to the second recording layer 16 is absorbed with difficulty through the second recording layer 16. This makes it also possible to provide the first recording layer 14 with a good recording mark as well as to improve the reflectivity of the first recording layer 14 to be detected by the photodetector 20.

Furthermore, the first recording layer 14 and the second recording layer 16 are irradiated with a laser beam and thereby provided with the recording mark 12 increased in thickness relative to the neighboring space portion 11. Thus, as shown in FIG. 1, the difference between the reflectivity of the space portion 11 and the reflectivity of the recording mark 12 is large in a wider range of thicknesses. The difference between the reflectivity of the space portion 11 and the reflectivity of the recording mark 12 is large in the vicinity of a thickness at which the reflectivity of the space portion 11 is maximized as well as in a region of thicknesses greater than that thickness. In particular, in the region of thicknesses greater than the thickness at which the reflectivity of the space portion 11 is maximized, a range of thicknesses providing large differences between the reflectivity of the space portion 11 and the reflectivity of the recording mark 12 is wide. That is, the range of settable thicknesses of the recording layer is wide. Thus, though the thickness of the first recording layer 14 is set in the vicinity of the thickness at which the reflectivity of the space portion 11 is maximized, and the second recording layer 16 is made thicker than the first recording layer 14 in order to make the reflectivity of the first recording layer 14 higher than the reflectivity of the second recording layer 16, it is possible to provide the second recording layer 16 with a sufficient difference between the reflectivity of the recording mark 12 and the reflectivity of the space portion 11. Additionally, by increasing the thickness of the second recording layer 16 in this manner, it is possible to form a good recording mark of a desired property in the second recording layer 16 as described above.

Now, a description will be given to a second exemplary embodiment of the present invention.

As shown in FIG. 4, an optical recording medium 30 according to the second exemplary embodiment is configured to include: a third recording layer 32 and a fourth recording layer 34 in addition to the first recording layer 14 and the second recording layer 16 in the optical recording medium 10 according to the first exemplary embodiment. The other portions are the same as or similar to those of the optical recording medium according to the first exemplary embodiment, therefore they are denoted by the same symbols as those of the first exemplary embodiment and description thereof is appropriately omitted.

The first recording layer 14, the second recording layer 16, the third recording layer 32, and the fourth recording layer 34 are arranged in that order one over another from the substrate 22 towards the incidence plane 18 of the laser beam. The spacer layer 26 is interposed between the first recording layer 14, the second recording layer 16, the third recording layer 32, and the fourth recording layer 34, respectively. Furthermore, the fourth recording layer 34 is in contact with the cover layer 24.

Like the material of the first recording layer 14 and the second recording layer 16, the material of the third recording layer 32 and the fourth recording layer 34 essentially consists of Bi and O, such that the percentage of the number of O atoms in the third recording layer 32 and the fourth recording layer 34 is 62% or more.

The third recording layer 32 is thicker than the second recording layer 16, and the fourth recording layer 34 is thicker than the third recording layer 32. That is, the optical recording medium 30 is designed such that the first recording layer 14, the second recording layer 16, the third recording layer 32, and the fourth recording layer 34, which are arranged one over another from the substrate 22 towards the incidence plane 18 of the laser beam, increase in thickness in that order. Accordingly, the optical recording medium 30 is configured such that the fourth recording layer 34, the third recording layer 32, the second recording layer 16, and the first recording layer 14 increase in reflectivity (of the recording layers themselves) in that order from the incidence plane 18 of the laser beam towards the substrate 22.

Like the optical recording medium 10, the optical recording medium 30 also allows the second recording layer 16, the third recording layer 32, and the fourth recording layer 34 to be provided with a good recording mark of a desired property because the second recording layer 16, the third recording layer 32, and the fourth recording layer 34 are thicker than the first recording layer 14.

Moreover, since the second recording layer 16, the third recording layer 32, the fourth recording layer 34 have an extinction coefficient of 0.35 or less, each laser beam irradiating the first recording layer 14, the second recording layer 16, and the third recording layer 32 is absorbed with difficulty through the second recording layer 16, the third recording layer 32, and the fourth recording layer 34 even when the second recording layer 16, the third recording layer 32, and the fourth recording layer 34 are formed to be thicker. This makes it also possible to provide the first recording layer 14, the second recording layer 16, the third recording layer 32 with a good recording mark as well as to increase the reflectivity of the first recording layer 14, the second recording layer 16, and the third recording layer 32 to be detected by the photodetector 20.

Furthermore, the first recording layer 14, the second recording layer 16, the third recording layer 32, and the fourth recording layer 34 are provided with the recording mark 12 increased in thickness relative to the neighboring space portion 11 by irradiation with a laser beam. Therefore, the difference between the reflectivity of the space portion 11 and the reflectivity of the recording mark 12 is large in a wider range of thicknesses. The difference between the reflectivity of the space portion 11 and the reflectivity of the recording mark 12 is large in the vicinity of a thickness at which the reflectivity of the space portion 11 is maximized as well- as in a region of thicknesses greater than that thickness. In particular, in the region of thicknesses greater than the thickness at which the reflectivity of the space portion 11 is maximized, a range of thicknesses providing large differences between the reflectivity of the space portion 11 and the reflectivity of the recording mark 12 is wide. That is, the range of settable thicknesses of the recording layer is wide. Therefore, though the thickness of the first recording layer 14 is set in the vicinity of the thickness at which the reflectivity of the space portion 11 is maximized, and the second recording layer 16, the third recording layer 32, and the fourth recording layer 34 are made thicker than the first recording layer 14 in order to make the reflectivity of the first recording layer 14 higher than the reflectivity of the second recording layer 16, the third recording layer 32, and the fourth recording layer 34, it is possible to provide the second recording layer 16, the third recording layer 32, and the fourth recording layer 34 with a sufficient difference between the reflectivity of the recording mark 12 and the reflectivity of the space portion 11. Additionally, by increasing the thickness of the second recording layer 16, the third recording layer 32, and the fourth recording layer 34 in this manner, it is possible to form a good recording mark of a desired property in the second recording layer 16, the third recording layer 32, and the fourth recording layer 34 as described above.

Now, a description will be given to a third exemplary embodiment of the present invention.

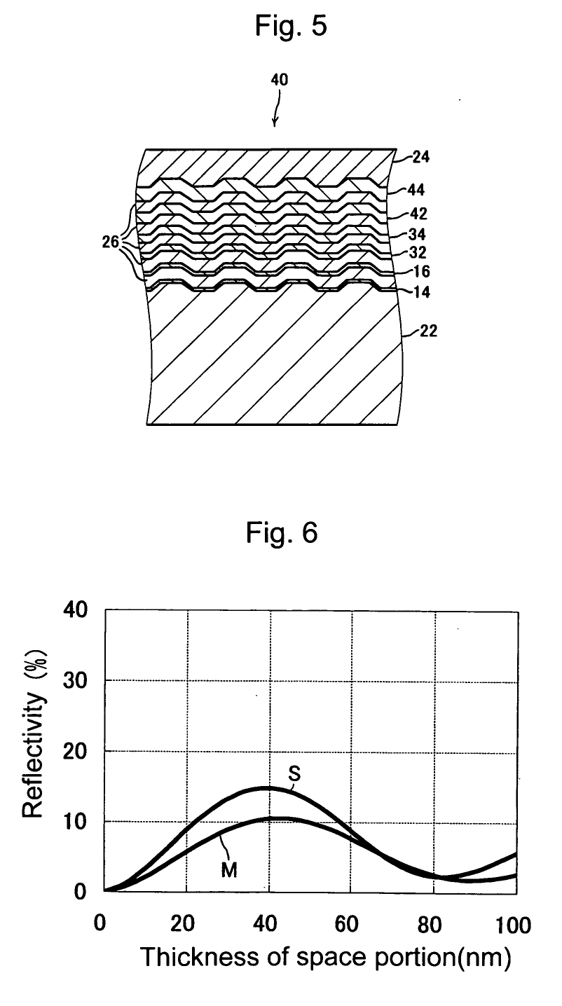

As shown in FIG. 5, an optical recording medium 40 according to the third exemplary embodiment is configured to include a fifth recording layer 42 and a sixth recording layer 44 in addition to the first recording layer 14, the second recording layer 16, the third recording layer 32, and the fourth recording layer 34 in the optical recording medium 30 according to the second exemplary embodiment. The other portions are the same as or similar to those of the optical recording medium according to the second exemplary embodiment, therefore they are denoted by the same symbols as those of the second exemplary embodiment and description thereof is appropriately omitted.

The first recording layer 14, the second recording layer 16, the third recording layer 32, the fourth recording layer 34, the fifth recording layer 42, and the sixth recording layer 44 are arranged in that order one over another from the substrate 22 towards the incidence plane 18 of the laser beam. The spacer layer 26 is interposed between the first recording layer 14, the second recording layer 16, the third recording layer 32, the fourth recording layer 34, the fifth recording layer 42, and the sixth recording layer 44, respectively. Furthermore, the sixth recording layer 44 is in contact with the cover layer 24.

Like the material of the first recording layer 14 or the like, the material of the fifth recording layer 42 and the sixth recording layer 44 essentially consists of Bi and O, such that the percentage of the number of O atoms in these fifth recording layer 42 and sixth recording layer 44 is 62% or more.

The fifth recording layer 42 is thicker than the fourth recording layer 34, and the sixth recording layer 44 is thicker than the fifth recording layer 42. That is, the optical recording medium 40 is designed such that the first recording layer 14, the second recording layer 16, the third recording layer 32, the fourth recording layer 34, the fifth recording layer 42, and the sixth recording layer 44, which are arranged one over another from the substrate 22 towards the incidence plane 18 of the laser beam, increase in thickness in that order. Accordingly, the optical recording medium 40 is configured such that the sixth recording layer 44, the fifth recording layer 42, the fourth recording layer 34, the third recording layer 32, the second recording layer 16, and the first recording layer 14 increase in reflectivity (of the recording layers themselves) in that order from the incidence plane 18 of the laser beam towards the substrate 22.

Like the optical recording medium 30, the optical recording medium 40 also allows the second recording layer 16, the third recording layer 32, the fourth recording layer 34, the fifth recording layer 42, and the sixth recording layer 44 to be provided with a good recording mark of a desired property because the second recording layer 16, the third recording layer 32, the fourth recording layer 34, the fifth recording layer 42, and the sixth recording layer 44 are thicker than the first recording layer 14.

Furthermore, since the second recording layer 16, the third recording layer 32, the fourth recording layer 34, the fifth recording layer 42, and the sixth recording layer 44 have an extinction coefficient of 0.35 or less, each laser beam irradiating the first recording layer 14, the second recording layer 16, the third recording layer 32, the fourth recording layer 34, and the fifth recording layer 42 is absorbed with difficulty through the second recording layer 16, the third recording layer 32, the fourth recording layer 34, the fifth recording layer 42, and the sixth recording layer 44 even when the second recording layer 16, the third recording layer 32, the fourth recording layer 34, the fifth recording layer 42, and the sixth recording layer 44 are formed to be thicker. This makes it also possible to provide the first recording layer 14, the second recording layer 16, the third recording layer 32, the fourth recording layer 34, and the fifth recording layer 42 with a good recording mark as well as to increase the reflectivity of the first recording layer 14, the second recording layer 16, the third recording layer 32, the fourth recording layer 34, and the fifth recording layer 42 to be detected by the photodetector 20.

Furthermore, the first recording layer 14, the second recording layer 16, the third recording layer 32, the fourth recording layer 34, the fifth recording layer 42, and the sixth recording layer 44 are provided with the recording mark 12 increased in thickness relative to the neighboring space portion 11 by irradiation with a laser beam. Therefore, the difference between the reflectivity of the space portion 11 and the reflectivity of the recording mark 12 is large in a wider range of thicknesses and the difference between the reflectivity of the space portion 11 and the reflectivity of the recording mark 12 is large in the vicinity of a thickness at which the reflectivity of the space portion 11 is maximized as well as in a region of thicknesses greater than that thickness. In particular, in the region of thicknesses greater than the thickness at which the reflectivity of the space portion 11 is maximized, a range of thicknesses providing large differences between the reflectivity of the space portion 11 and the reflectivity of the recording mark 12 is large. That is, the range of settable thicknesses of the recording layer is wide. Thus, though the thickness of the first recording layer 14 is set in the vicinity of the thickness at which the reflectivity of the space portion 11 is maximized, and the second recording layer 16, the third recording layer 32, the fourth recording layer 34, the fifth recording layer 42, and the sixth recording layer 44 are made thicker than the first recording layer 14 in order to make the reflectivity of the first recording layer 14 higher than the reflectivity of the second recording layer 16, the third recording layer 32, the fourth recording layer 34, the fifth recording layer 42, and the sixth recording layer 44e, it is possible to provide the second recording layer 16, the third recording layer 32, the fourth recording layer 34, the fifth recording layer 42, and the sixth recording layer 44 with a sufficient difference between the reflectivity of the recording mark 12 and the reflectivity of the space portion 11. Additionally, by increasing the thickness of the second recording layer 16, the third recording layer 32, the fourth recording layer 34, the fifth recording layer 42, and the sixth recording layer 44 in this manner, it is possible to form a good recording mark of a desired property in the second recording layer 16, the third recording layer 32, the fourth recording layer 34, the fifth recording layer 42, and the sixth recording layer 44 as described above.

Note that in the aforementioned first to third exemplary embodiments, the first recording layer 14 is formed in a thickness generally equal to the thickness at which the reflectivity of the space portion 11 is maximized. However, the thickness of the first recording layer 14 may be either thinner or thicker than the thickness at which the maximum reflectivity is provided, so long as the first recording layer 14 is provided with a sufficient difference between the reflectivity of the recording mark 12 and the reflectivity of the space portion 11 as well as the recording layers increase in reflectivity from the incidence plane 18 of the laser beam towards the substrate 22.

Moreover, in the aforementioned first to third exemplary embodiments, the first recording layer 14, the second recording layer 16, the third recording layer 32, the fourth recording layer 34, the fifth recording layer 42, and the sixth recording layer 44 are formed of a material which provides the space portion 11 with the maximum reflectivity in thickness of approximately 40 nm. However, the first recording layer 14, the second recording layer 16, the third recording layer 32, the fourth recording layer 34, the fifth recording layer 42, and the sixth recording layer 44 may also be formed of a material which provides the space portion 11 with the maximum reflectivity in thickness either less than or greater than 40 nm.

Furthermore, in the aforementioned first to third exemplary embodiments, the material of the first recording layer 14, the second recording layer 16, the third recording layer 32, the fourth recording layer 34, the fifth recording layer 42, and the sixth recording layer 44 essentially consists of Bi and O. However, the material of the first recording layer 14, the second recording layer 16, the third recording layer 32, the fourth recording layer 34, the fifth recording layer 42, and the sixth recording layer 44 may also be another material so long as the material provides an extinction coefficient of, e.g., as low as 0.35 or less. Even in this case, such a material is preferably employed that is provided with a recording mark increased in thickness relative to the neighboring space portion by irradiation with a laser beam. For example, a material containing Bi, Ge, and N can be employed.

In the aforementioned first to third exemplary embodiments, the first recording layer 14, the second recording layer 16, the third recording layer 32, the fourth recording layer 34, the fifth recording layer 42, and the sixth recording layer 44 contain common constituent elements (Bi and O). However, the first recording layer 14 may not need to contain a common constituent element that is contained in the second recording layer 16, the third recording layer 32, the fourth recording layer 34, the fifth recording layer 42, and the sixth recording layer 44. For example, the first recording layer 14 may be formed of a material having an extinction coefficient greater than 0.35. Furthermore, the first recording layer 14 may also be formed of a material with which a recording mark increased in thickness relative to the neighboring space portion is not provided by irradiation with a laser beam.

In the aforementioned second exemplary embodiment, the optical recording medium 30 is designed such that the first recording layer 14, the second recording layer 16, the third recording layer 32, and the fourth recording layer 34 increase in thickness in that order from the substrate 22 towards the incidence plane 18 of the laser beam and the reflectivities (of the recording layers themselves) increase in the order of the fourth recording layer 34, the third recording layer 32, the second recording layer 16, and the first recording layer 14 from the incidence plane 18 of the laser beam towards the substrate 22. In the aforementioned third exemplary embodiment, the optical recording medium 40 is designed such that the first recording layer 14, the second recording layer 16, the third recording layer 32, the fourth recording layer 34, the fifth recording layer 42, and the sixth recording layer 44 increase in thickness in that order from the substrate 22 towards the incidence plane 18 of the laser beam. Additionally, the reflectivity (of the recording layers themselves) increases in the order of the sixth recording layer 44, the fifth recording layer 42, the fourth recording layer 34, the third recording layer 32, the second recording layer 16, and the first recording layer 14 from the incidence plane 18 of the laser beam towards the substrate 22. However, as for a combination of any two of these layers, if the upper recording layer located relatively closer to the incidence plane 18 of the laser beam is thicker than the lower recording layer located farther away from the incidence plane 18 of the laser beam relative to the upper recording layer, other combinations may not need to satisfy this thickness relationship. In this case, a certain effect can also be obtained to improve the recording sensitivity of the upper recording layer located relatively closer to the incidence plane 18 of the laser beam.

Furthermore, in FIG. 2 of the aforementioned first exemplary embodiment, the recording mark 12 is uniform in thickness as a whole. However, so long as at least a portion is thicker than the neighboring space portion, the shape of the recording mark is not limited to a particular one. Thus, the recording mark 12 may be thicker in its entirety than the neighboring space portion and the thickness may vary depending on the portion. Alternatively, only a portion may be thicker than the neighboring space portion and the other portions may be equal in thickness to the space portion. For example, the thickness may be the largest in the vicinity of the center and reduced with distance from the center. In practice, a recording mark of such a shape is often formed. Note that the thickness of each portion of a recording mark can be checked by observing the cross-section of the recording mark by TEM (Transmission Electron Microscopy).

Furthermore, in the aforementioned first to third exemplary embodiments, the optical recording medium 10, the optical recording medium 30, and the optical recording medium 40 are configured such that any of the first recording layer 14, the second recording layer 16, the third recording layer 32, the fourth recording layer 34, the fifth recording layer 42, and the sixth recording layer 44 is directly in contact with one of the substrate 22, the cover layer 24, and the spacer layer 26. However, for example, a reflective layer may be provided between the first recording layer 14 and the substrate 22. The reflective layer may be formed of Al, Ag, Au, Cu, Mg, Ti, Cr, Fe, Co, Ni, Zn, Ge, Pt, or Pd, or an alloy thereof. Among these materials, Al, Ag, Au, Cu, or an alloy AgPdCu may be preferably employed in terms of a high reflectivity. Note that the reflective layer can also be formed of a dielectric material. Furthermore, the dielectric layer may be provided on either one or both sides of some or all of the recording layers. The dielectric layer can be formed of, e.g., an oxide such as SiO₂, Al₂O₃, ZnO, CeO₂, and Ta₂O₅, a nitride such as SiN, AlN, GeN, GeCrN, and TiO₂, a sulfide such as ZnS, or a material that is mainly composed of a combination of these substances, such as a mixture of ZnS and SiO₂.

Furthermore, the optical recording medium 10 of the aforementioned first exemplary embodiment includes two recording layers, the optical recording medium 30 of the aforementioned second exemplary embodiment includes four recording layers, and the optical recording medium 40 of the aforementioned third exemplary embodiment includes six recording layers. However, the present invention is also applicable to an optical recording medium which includes three recording layers or to an optical recording medium which includes five recording layers as well as to an optical recording medium which includes seven or more recording layers.

Furthermore, in the aforementioned first to third exemplary embodiments, the optical recording media 10, 30, and 40 are a single-sided recording medium which has recording layers only on one side. However, the present invention should be also applicable to a double-sided optical recording medium which has recording layers on both sides.

Furthermore, in the aforementioned first to third exemplary embodiments, the optical recording media 10, 30, and 40 are configured such that the cover layer 24 is thinner than the substrate 22. However, the present invention should be also applicable to an optical recording medium like a DVD in which the substrate and the cover layer are equal to each other in thickness. In this case, the substrate and cover layer are generally equal in shape to each other; however, note that the one which is irradiated with a recording/reproducing laser beam is herein referred to as the cover layer.

### WORKING EXAMPLE 1

Five types of optical recording media with two recording layers were manufactured which had the same configuration as that of the optical recording medium 10 according to the aforementioned first exemplary embodiment. These five types of optical recording media were designed to have the second recording layer 16 formed in thicknesses different from each other, with the other portions than the second recording layer 16 being identical to each other.

More specifically, the first recording layer 14 and the second recording layer 16 were formed of a material of Bi and O, so that the percentage of the number of O atoms in these first recording layer 14 and second recording layer 16 was 68% (62% or more), and the percentage of the number of Bi atoms was 32%, with no other elements added. The first recording layer 14 was formed in a thickness of approximately 45 nm in the vicinity of which the material provides the maximum reflectivity. On the other hand, the second recording layer 16 was formed in five types of thicknesses of 47 nm, 53 nm, 68 nm, 72 nm, and 74 nm, which were greater than the thickness of the first recording layer 14.

On these five types of optical recording media, measurements were made to determine the reflectivity, the recording sensitivity, the 8T_C/N value, and the extinction coefficient of (unrecorded portions of) the first recording layer 14 and the second recording layer 16. The results of the measurements are shown in Table 1. Furthermore, the composition and deposition conditions of the first recording layer 14 and the second recording layer 16 are also indicated in Table 1. Note that such reproducing laser beams as having the same power were used to measure the reflectivity of the first recording layer 14 and the reflectivity of the second recording layer 16. The reflectivities shown in Table 1 are those detected by the photodetector 20. On the other hand, the recording sensitivities were measured as follows. First, each optical recording medium was irradiated with laser beams at various powers to form recording marks 12. Then, a recording and reproducing apparatus was used to measure the amount of jitter of each recording mark 12. Since the power of a laser beam used to form a recording mark 12 with the lowest amount of jitter is preferable as the power of the laser beam for the optical recording medium, the power was captured as the recording sensitivity. Note that the power of a laser beam refers to the intensity of the laser beam reaching the incidence plane 18 and represented in terms of electric power. It can be seen that the lower the laser beam power that shows the recording sensitivity, the easier the formation of a recording mark and the better the recording sensitivity.

TABLE 1

| | | | | | | | | Deposition conditions | | |
|---|---|---|---|---|---|---|---|---|---|---|
| | | | Recording | | Extinction | Composition | | Deposition | Gas flow | |
| | Thickness | Reflectivity | sensitivity | 8T C/N | coefficient | (at %) | | power (W) | rate (sccm) | |
| | (nm) | (%) | (mW) | (dB) | k | Bi | O | Bi | Ar | O₂ |
| Second recording layer | 47 | 9.3 | 4.5 | 56 | 0.16 | 32 | 68 | 200 | 50 | 15 |
| First recording layer | 45 | 5.3 | 8.0 | 55 | | | | | | 15 |
| Second recording layer | 53 | 8.0 | 4.0 | 57 | | | | | | 15 |
| First recording layer | 45 | 5.1 | 8.0 | 55 | | | | | | 15 |
| Second recording layer | 68 | 4.2 | 3.5 | 58 | | | | | | 15 |
| First recording layer | 45 | 4.5 | 8.5 | 55 | | | | | | 15 |
| Second recording layer | 72 | 3.5 | 3.5 | 58 | | | | | | 15 |
| First recording layer | 45 | 4.2 | 8.5 | 55 | | | | | | 15 |
| Second recording layer | 74 | 2.5 | 3.0 | 57 | | | | | | 15 |
| First recording layer | 45 | 3.8 | 9.0 | 55 | | | | | | 15 |

### WORKING EXAMPLE 2

In contrast to the aforementioned Working Example 1, one type of optical recording medium was manufactured, in which the first recording layer 14 and the second recording layer are formed of a material of Bi, O, and Ge, so that the percentage of the number of Bi, O, and Ge atoms in these first recording layer 14 and second recording layer 16 is different in each recording layer.

More specifically, the percentage of the number of Bi, O, and Ge atoms in the first recording layer 14 and the second recording layer 16 was set to the percentages shown in Table 2. As with the aforementioned Working Example 1, the first recording layer 14 was formed in a thickness of approximately 45 nm. On the other hand, the second recording layer 16 was formed in a thickness of 68 nm (which is thicker than the first recording layer 14).

On this optical recording medium, measurements were made to determine the reflectivity, the recording sensitivity, the 8T_C/N value, and the extinction coefficient of the first recording layer 14 and the second recording layer 16. The results of the measurements are shown in Table 2. Furthermore, the deposition conditions of the first recording layer 14 and the second recording layer 16 are also indicated in Table 2.

TABLE 2

| | | | | | | | | | Deposition conditions | | | |
|---|---|---|---|---|---|---|---|---|---|---|---|---|
| | | | Recording | | Extinction | Composition | | | Deposition | | Gas flow | |
| | Thickness | Reflectivity | sensitivity | 8T C/N | coefficient | (at %) | | | power (W) | | rate (sccm) | |
| | (nm) | (%) | (mW) | (dB) | k | Bi | O | Ge | Bi | Ge | Ar | O₂ |
| Second recording layer | 65 | 5.0 | 7.0 | 57 | 0.13 | 25 | 71 | 4 | 100 | 150 | 50 | 12 |
| First recording layer | 50 | 4.8 | 6.5 | 56 | 0.15 | 29 | 70 | 1 | 100 | 100 | 50 | 14 |

### WORKING EXAMPLE 3

In contrast to the aforementioned Working Example 1, twelve types of optical recording media were manufactured in which the first recording layer 14 and the second recording layer were formed of different materials.

More specifically, the first recording layer 14 was formed of a material of Bi and O, and a material with Fe added to Bi and O. On the other hand, the second recording layer 16 was formed of a material of Bi and O, and a material with Al, Mg, Zn, Ge, Y, Sn, Sb, V, Dy, and Ti added to Bi and O.

On these twelve types of optical recording media, measurements were made to determine the reflectivity, the recording sensitivity, the 8T_C/N value, and the extinction coefficient of the first recording layer 14 and the second recording layer 16. The results of the measurements are shown in Table 3. Furthermore, the composition and deposition conditions of the first recording layer 14 and the second recording layer 16 are also indicated in Table 3.

TABLE 3

| | | | | | | | | | | Deposition conditions | | | |
|---|---|---|---|---|---|---|---|---|---|---|---|---|---|
| | | | Recording | | Extinction | Composition | | | | Deposition | | Gas flow | |
| | Thickness | Reflectivity | sensitivity | 8T C/N | coefficient | (at %) | | | | power (W) | | rate (sccm) | |
| | (nm) | (%) | (mW) | (dB) | k | Bi | X, Z | | O | Bi | X, Z | Ar | O₂ |
| Second recording layer | 68 | 4.0 | 5.5 | 58 | 0.12 | 27 | 5 | (Al) | 68 | 200 | 800 | 50 | 13 |
| First recording layer | 45 | 4.2 | 5.5 | 58 | 0.25 | 27 | 6 | (Fe) | 67 | 200 | 400 | 50 | 15 |
| Second recording layer | 68 | 4.2 | 3.5 | 58 | 0.16 | 32 | 0 | | 68 | 200 | — | 50 | 15 |
| First recording layer | 45 | 4.2 | 6.0 | 57 | 0.25 | 24 | 8 | (Fe) | 68 | 200 | 800 | 50 | 15 |
| Second recording layer | 68 | 4.0 | 5.5 | 58 | 0.12 | 27 | 5 | (Al) | 68 | 200 | 800 | 50 | 13 |
| First recording layer | 45 | 4.4 | 7.0 | 55 | 0.16 | 32 | 0 | | 68 | 200 | — | 50 | 15 |
| Second recording layer | 68 | 5.6 | 6.0 | 57 | 0.13 | 22 | 14 | (Mg) | 64 | 200 | 800 | 50 | 15 |
| First recording layer | 45 | 5.3 | 7.0 | 55 | 0.16 | 32 | 0 | | 68 | 200 | — | 50 | 15 |
| Second recording layer | 68 | 6.1 | 6.5 | 55 | 0.12 | 24 | 8 | (Zn) | 68 | 200 | 600 | 50 | 20 |
| First recording layer | 45 | 5.2 | 6.5 | 55 | 0.16 | 32 | 0 | | 68 | 200 | — | 50 | 15 |
| Second recording layer | 68 | 5.3 | 7.5 | 58 | 0.12 | 25 | 4 | (Ge) | 71 | 100 | 150 | 50 | 12 |
| First recording layer | 45 | 5.4 | 6.5 | 55 | 0.16 | 32 | 0 | | 68 | 200 | — | 50 | 15 |
| Second recording layer | 68 | 6.2 | 6.5 | 56 | 0.13 | 27 | 3 | (Y) | 70 | 150 | 600 | 50 | 15 |
| First recording layer | 45 | 5.3 | 7.0 | 55 | 0.16 | 32 | 0 | | 68 | 200 | — | 50 | 15 |
| Second recording layer | 68 | 5.3 | 6.0 | 56 | 0.13 | 25 | 8 | (Sn) | 67 | 200 | 200 | 50 | 18 |
| First recording layer | 45 | 5.4 | 7.0 | 55 | 0.16 | 32 | 0 | | 68 | 200 | — | 50 | 15 |
| Second recording layer | 68 | 5.8 | 6.5 | 58 | 0.13 | 23 | 5 | (Sb) | 72 | 200 | 200 | 50 | 20 |
| First recording layer | 45 | 5.1 | 7.0 | 55 | 0.16 | 32 | 0 | | 68 | 200 | — | 50 | 15 |
| Second recording layer | 68 | 5.3 | 6.0 | 57 | 0.14 | 29 | 4 | (V) | 67 | 200 | 400 | 50 | 15 |
| First recording layer | 45 | 5.4 | 7.0 | 55 | 0.16 | 32 | 0 | | 68 | 200 | — | 50 | 15 |
| Second recording layer | 68 | 5.2 | 6.0 | 59 | 0.14 | 25 | 7 | (Dy) | 68 | 150 | 600 | 50 | 15 |
| First recording layer | 45 | 5.0 | 7.0 | 55 | 0.16 | 32 | 0 | | 68 | 200 | — | 50 | 15 |
| Second recording layer | 68 | 6.0 | 6.0 | 59 | 0.13 | 34 | 2 | (Ti) | 64 | 200 | 600 | 50 | 12 |
| First recording layer | 45 | 4.8 | 7.5 | 55 | 0.16 | 32 | 0 | | 68 | 200 | — | 50 | 15 |

### WORKING EXAMPLE 4

An optical recording medium with four recording layers was manufactured which was configured in the same manner as the optical recording medium 30 of the aforementioned second exemplary embodiment.

More specifically, one type of optical recording medium was manufactured in which the first recording layer 14, the second recording layer 16, the third recording layer 32, and the fourth recording layer 34 are formed of a material of Bi, O, and Ge, such that the percentage of the number of Bi, O, and Ge atoms in these first recording layer 14, second recording layer 16, third recording layer 32, and fourth recording layer 34 is different in each recording layer. The first recording layer 14 was formed in a thickness of approximately 48 nm which maximizes reflectivity of the material. In contrast to this, the second recording layer 16, the third recording layer 32, and the fourth recording layer 34 were formed in thicknesses of 62 nm, 68 nm, and 73 nm, respectively, which are thicker than the first recording layer 14.

On this optical recording medium, measurements were made to determine the reflectivity, the recording sensitivity, the 8T_C/N value, and the extinction coefficient of the first recording layer 14, the second recording layer 16, the third recording layer 32, and the fourth recording layer 34. The results of the measurements are shown in Table 4. Furthermore, the composition and deposition conditions of the first recording layer 14, the second recording layer 16, the third recording layer 32, and the fourth recording layer 34 are also indicated in Table 4.

TABLE 4

| | | | | | | | | | Deposition conditions | | | |
|---|---|---|---|---|---|---|---|---|---|---|---|---|
| | | | Recording | | Extinction | Composition | | | Deposition | | Gas flow | |
| | Thickness | Reflectivity | sensitivity | 8T C/N | coefficient | (at %) | | | Power (W) | | Rate (sccm) | |
| | (nm) | (%) | (mW) | (dB) | k | Bi | O | Ge | Bi | Ge | Ar | O₂ |
| Fourth recording layer | 73 | 3.5 | 9.0 | 58 | 0.09 | 23 | 68 | 9 | 75 | 200 | 50 | 12 |
| Third recording layer | 68 | 4.1 | 9.0 | 55 | 0.11 | 25 | 68 | 7 | 85 | 200 | 50 | 12 |
| Second recording layer | 62 | 3.5 | 10.0 | 55 | 0.13 | 25 | 71 | 4 | 100 | 150 | 50 | 12 |
| First recording layer | 48 | 3.5 | 9.0 | 56 | 0.15 | 29 | 70 | 1 | 100 | 100 | 50 | 14 |

### WORKING EXAMPLE 5

As with the optical recording medium 40 of the aforementioned third exemplary embodiment, an optical recording medium with six recording layers was manufactured.

More specifically, the first recording layer 14 was formed in a stack of a Si layer and a Cu layer. Note that the Cu layer was on the substrate 22 side, and the Si layer was on the cover layer 24 side.

Furthermore, this one type of optical recording medium manufactured was configured such that the second recording layer 16, the third recording layer 32, the fourth recording layer 34, the fifth recording layer 42, and the sixth recording layer 44 were formed of a material of Bi, O, and Ge, such that the percentage of the number of Bi, O, and Ge atoms in these second recording layer 16, third recording layer 32, fourth recording layer 34, fifth recording layer 42, and sixth recording layer 44 was different in each recording layer.

Each of the Si layer and the Cu layer of the first recording layer 14 was formed in a thickness of 6 nm, so that the first recording layer 14 had a total thickness of 12 nm. Note that provided on both sides of the first recording layer 14 was a dielectric layer which was formed of a material containing a mixture of ZnS and SiO₂ (with a mixture ratio (the number of molecules) of ZnS to SiO₂ equal to 80:20). Each of the dielectric layers had a thickness of 40 nm. Furthermore, there was provided a reflective layer of a material of a AgPdCu alloy between the dielectric layer on the substrate 22 side and the substrate 22. The reflective layer was formed in a thickness of 100 nm.

On the other hand, the second recording layer 16, the third recording layer 32, the fourth recording layer 34, the fifth recording layer 42, and the sixth recording layer 44 were formed in thicknesses of 33 nm, 37 nm, 40 nm, 43 nm, and 46 nm, respectively. Note that a dielectric layer of TiO₂ was provided on both sides of the second recording layer 16, the third recording layer 32, the fourth recording layer 34, the fifth recording layer 42, and the sixth recording layer 44. The dielectric layers on both sides of the second recording layer 16 were formed each in a thickness of 10 nm. The dielectric layers on both sides of the third recording layer 32, the fourth recording layer 34, and the fifth recording layer 42 were formed each in a thickness of 14 nm. The dielectric layers respectively disposed on both sides of the sixth recording layer 16 were formed each in a thickness of 15 nm.

On this optical recording medium, measurements were made to determine the reflectivity, the recording sensitivity, the 8T_C/N value, and the extinction coefficient of the first recording layer 14, the second recording layer 16, the third recording layer 32, the fourth recording layer 34, the fifth recording layer 42, and the sixth recording layer 44. The results of the measurements are shown in Table 5. Furthermore, the composition and deposition conditions of the second recording layer 16, the third recording layer 32, the fourth recording layer 34, the fifth recording layer 42, and the sixth recording layer 44 are also indicated in Table 5.

TABLE 5

| | | | | | | | | | | | Deposition conditions | | | |
|---|---|---|---|---|---|---|---|---|---|---|---|---|---|---|
| | | | Recording | | Extinction | Composition | | | | | Deposition | | Gas flow | |
| | Thickness | Reflectivity | sensitivity | 8T C/N | coefficient | (at %) | | | | | power (W) | | rate (sccm) | |
| | (nm) | (%) | (mW) | (dB) | k | Bi | O | Ge | Si | Cu | Bi | Ge | Ar | O₂ |
| Sixth recording layer | 46 | 4.4 | 10.8 | 61 | 0.07 | 20 | 67 | 13 | — | — | 70 | 300 | 50 | 15 |
| Fifth recording layer | 43 | 4.1 | 10.6 | 60 | 0.08 | 22 | 67 | 11 | — | — | 78 | 300 | 50 | 15 |
| Fourth recording layer | 40 | 3.1 | 11.4 | 58 | 0.11 | 22 | 68 | 10 | — | — | 80 | 290 | 50 | 15 |
| Third recording layer | 37 | 2.9 | 11.0 | 57 | 0.13 | 25 | 68 | 7 | — | — | 80 | 220 | 50 | 15 |
| Second recording layer | 33 | 2.9 | 12.0 | 57 | 0.15 | 28 | 70 | 2 | — | — | 150 | 200 | 50 | 20 |
| First recording layer | 6 | 2.1 | 12.2 | 57 | 1.85 | — | — | — | 100 | — | — | — | — | — |
| | 6 | | | | 3.71 | — | — | — | | 100 | — | — | — | — |

### COMPARATIVE EXAMPLE

In contrast to the aforementioned Working Example 1, an optical recording medium was manufactured in which the thickness of the second recording layer was equal to the thickness of the first recording layer 14, and another optical recording medium was manufactured in which the thickness of the second recording layer was less than the thickness of the first recording layer 14.

More specifically, two types of optical recording media were manufactured in which with the first recording layer 14 formed in a thickness of approximately 45 nm as in the aforementioned Working Example 1, the second recording layer 16 was formed in a thickness of 45 nm which was equal in thickness to the first recording layer 14, and the second recording layer 16 was formed in a thickness of 20 nm which was less in thickness than the first recording layer 14.

On these two types of optical recording media, measurements were made to determine the reflectivity, the recording sensitivity, the 8T_C/N value, and the extinction coefficient of the first recording layer 14 and the second recording layer 16. The results of the measurements are shown in Table 6. Furthermore, the composition and deposition conditions of the first recording layer 14 and the second recording layer 16 are also indicated in Table 6.

TABLE 6

| | | | | | | | | Deposition conditions | | |
|---|---|---|---|---|---|---|---|---|---|---|
| | | | Recording | | Extinction | Composition | | Deposition | Gas flow | |
| | Thickness | Reflectivity | sensitivity | 8T C/N | coefficient | (at %) | | power (W) | rate (sccm) | |
| | (nm) | (%) | (mW) | (dB) | k | Bi | O | Bi | Ar | O₂ |
| Second recording layer | 20 | 5.2 | 8.0 | 40 | 0.16 | 32 | 68 | 200 | 50 | 15 |
| First recording layer | 45 | 5.8 | 6.5 | 55 | | | | | | |
| Second recording layer | 45 | 11.0 | 5.0 | 55 | | | | | | |
| First recording layer | 45 | — | — | — | | | | | | |

As shown in Tables 1 to 5, each of the optical recording media according to the Working Examples 1 to 5 had an 8T_C/N value as good as 50 or more for each recording layer. That is to say, each of the optical recording media according to the Working Examples 1 to 5 was provided on each recording layer thereof with good recording marks 12. Moreover, with the optical recording media according to the Working Examples 1 to 5, the reflectivities of two adjacent recording layers detected by the photodetector 20 were as close to each other as within a range of less than two times. Furthermore, in the Working Example 3, the first recording layer 14 and the second recording layer 16 were formed of a material containing different constituent elements, thereby making it possible to provide each recording layer with generally the same reflectivity. It was also made possible in some of the optical recording media to provide the first recording layer 14 and the second recording layer 16 with generally the same recording sensitivity. On the other hand, in the Working Example 2 and the Working Example 4, each recording layer was formed of a material of common constituent elements but with different composition percentages, thereby making it possible to provide each recording layer with generally the same reflectivity and recording sensitivity. By employing the common constituent elements for the recording layers in this manner, it is possible to utilize the common deposition apparatus for deposition of each recording layer, thereby reducing costs for the facilities.

In contrast to this, one of the two types of optical recording media according to the Comparative Example, which was provided with the second recording layer 16 having a thickness less than that of the first recording layer 14, was found to have an 8T_C/N value of 40 for the second recording layer. Thus, the recording marks 12 formed in the second recording layer were unable to provide a desired reproduction property. This is thought to be due to the fact that the second recording layer 16 is too thin. On the other hand, with the other optical recording medium which was provided with the second recording layer 16 having a thickness equal to that of the first recording layer 14, a laser beam was tried to be focused on the first recording layer 14 in vain but was unintentionally focused on the second recording layer 16. Thus, no recording mark was formed in the first recording layer 14. Thus, no evaluation could be performed on the first recording layer 14. This is thought to be due to the fact that the reflectivity of the first recording layer 14 detected by the photodetector 20 was excessively lower than the reflectivity of the second recording layer 16.

What is claimed is:

1. An optical recording medium comprising a plurality of recording layers, one of the recording layers located relatively closer to an incidence plane of a laser beam being thicker than another recording layer located farther away from the incidence plane of the laser beam with respect to the one recording layer.

2. The optical recording medium according to claim 1, wherein
at least one of the recording layers located closer to the incidence plane of the laser beam with respect to a recording layer located at the farthest position from the incidence plane is provided with a recording mark increased in thickness relative to a neighboring space portion by irradiation with the laser beam.

3. The optical recording medium according to claim 1, wherein
at least one of the recording layers located closer to the incidence plane of the laser beam with respect to a recording layer located at the farthest position from the incidence plane has an extinction coefficient of 0.35 or less.

4. The optical recording medium according to claim 2, wherein
at least one of the recording layers located closer to the incidence plane of the laser beam with respect to a recording layer located at the farthest position from the incidence plane has an extinction coefficient of 0.35 or less.

5. The optical recording medium according to claim 3, wherein
a material of the recording layers has a property of providing the space portion with a maximum reflectivity at a given thickness; and
at least one of the recording layers located closer to the incidence plane of the laser beam with respect to a recording layer located at the farthest position from the incidence plane is formed in a larger thickness than a thickness at which the space portion has the maximum reflectivity.

6. The optical recording medium according to claim 4, wherein
a material of the recording layers has a property of providing the space portion with a maximum reflectivity at a given thickness; and
at least one of the recording layers located closer to the incidence plane of the laser beam with respect to a recording layer located at the farthest position from the incidence plane is formed in a larger thickness than a thickness at which the space portion has the maximum reflectivity.

7. The optical recording medium according to claim 1, wherein
at least one of the recording layers located closer to the incidence plane of the laser beam with respect to a recording layer located at the farthest position from the incidence plane essentially consists of Bi and O, such that the percentage of the number of O atoms in the recording layer is 62% or greater.

8. The optical recording medium according to claim 2, wherein
at least one of the recording layers located closer to the incidence plane of the laser beam with respect to a recording layer located at the farthest position from the incidence plane essentially consists of Bi and O, such that the percentage of the number of O atoms in the recording layer is 62% or greater.

9. The optical recording medium according to claim 3, wherein
at least one of the recording layers located closer to the incidence plane of the laser beam with respect to a recording layer located at the farthest position from the incidence plane essentially consists of Bi and O, such that the percentage of the number of O atoms in the recording layer is 62% or greater.

10. The optical recording medium according to claim 4, wherein
at least one of the recording layers located closer to the incidence plane of the laser beam with respect to a recording layer located at the farthest position from the incidence plane essentially consists of Bi and O, such that the percentage of the number of O atoms in the recording layer is 62% or greater.

11. The optical recording medium according to claim 5, wherein
at least one of the recording layers located closer to the incidence plane of the laser beam with respect to a recording layer located at the farthest position from the incidence plane essentially consists of Bi and O, such that the percentage of the number of O atoms in the recording layer is 62% or greater.

12. The optical recording medium according to claim 6, wherein
at least one of the recording layers located closer to the incidence plane of the laser beam with respect to a recording layer located at the farthest position from the incidence plane essentially consists of Bi and O, such that the percentage of the number of O atoms in the recording layer is 62% or greater.
